(19) United States
(12) Patent Application Publication
(10) Pub. No.: US 2025/0236964 A1
(43) Pub. Date: Jul. 24, 2025

(54) METHODS, DEVICES, AND SYSTEMS FOR MITIGATING HYDROGEN CROSSOVER WITHIN AN ELECTROCHEMICAL CELL

(71) Applicant: ELECTRIC HYDROGEN CO., Natick, MA (US)

(72) Inventors: Syed Dawar SAJJAD, Boston, MA (US); David EAGLESHAM, Lexington, MA (US); Nemanja DANILOVIC, El Sobrante, CA (US); Jigish TRIVEDI, Pleasanton, CA (US)

(21) Appl. No.: 18/703,628

(22) PCT Filed: Mar. 8, 2023
(86) PCT No.: PCT/US2023/014813

§ 371 Date: Apr. 22, 2024

Related U.S. Application Data
(60) Provisional application No. 63/317,593, filed on Mar. 8, 2022.

(51) Int. Cl. C25B 9/23; C25B 11/032; C25B 11/081; C25B 11/089; C25B 11/091; C25B 13/02

(52) U.S. Cl. CPC C25B 9/23; C25B 11/032; C25B 11/081; C25B 11/089; C25B 11/091; C25B 13/02

(57) ABSTRACT

Electrochemical cells having recombination layers are disclosed herein. One example of such a cell includes a membrane configured to be positioned between an anode flow field and a cathode flow field of the electrochemical cell. The cell further includes a recombination layer configured to be positioned between the anode flow field and at least a portion of the membrane. The recombination layer includes a catalyst configured to assist in a formation of water from hydrogen gas and oxygen gas produced within the electrochemical cell, therein mitigating any hydrogen gas crossover from a cathode side to an anode side of the electrochemical cell.

The present patent document claims the benefit of U.S. Provisional Patent Application No. 63/317,593, filed Mar. 8, 2022, which is hereby incorporated by reference in its entirety.

### FIELD

The following disclosure relates to electrochemical or electrolysis cells and components thereof. More specifically, the following disclosure relates to methods, devices, and systems for mitigating hydrogen crossover within an electrochemical cell through the addition of a recombination layer or a multi-layered membrane within the cell.

### BACKGROUND

An electrochemical or electrolysis cell or system uses electrical energy to drive a chemical reaction. For example, within a water splitting electrolysis reaction within the electrolysis cell, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive installation of electrolyzer systems.

Various challenges are present with operation at the membrane of an electrolysis cell. These challenges are not well described within the literature and are not fully appreciated in the field.

For example, ion exchange membrane (IEM) performance may be related to the thickness of the membrane. That is, a thinner membrane will conduct more protons/current at a given overpotential. However, very thin membranes are problematic because of their rapid loss of mechanical and chemical integrity due to degradation during operation. Additionally, thin membranes may present challenges with an increased risk of crossover of hydrogen from the cathode (H₂) side to the anode (O₂) side.

Specifically, hydrogen that is formed in the cathode side of the cell may diffuse back through the proton exchange membrane and into the anode side of the cell where oxygen is being formed as a result of the water splitting reaction. This hydrogen crossover may lead to safety problems and/or performance losses. For example, the lower flammability limit (LFL) of hydrogen in oxygen is approximately 4 vol. %. As such, operating conditions of a proton exchange membrane water electrolysis (PEMWE) cell are set such that the hydrogen concentration in the anodic stream does not approach 50% of the LFL.

Additional challenges for hydrogen crossover may exist for cells or cell stacks that operate under pressurized conditions (e.g., wherein at least one side of the cell is operating at a pressure greater than atmospheric pressure). For instance, an electrolysis cell or stack may be configured to operate under asymmetric pressure conditions wherein the cathode/hydrogen side of the cell is operating at an elevated pressure greater than the pressure of the anode/oxygen side of the cell. This lower (e.g., atmospheric) pressure at the anode side of the cell may be done to reduce corrosion of the metallic components at the anode and minimize the hazards of fire and explosion due to the presence of pressurized oxygen. This asymmetric pressure operation of the cell may further increase the chance for hydrogen crossover from the cathode side of the cell to the anode side of the cell, therein exacerbating the risk of flammability occurrence.

Additional challenges may exist in PEMWE cells having a thin cell membrane, as the reduced thickness of the membrane may provide less restriction or buffer for mitigating hydrogen crossover, therein increasing the danger of hydrogen explosively reacting with oxygen.

In the current state of the art, an intricate and laborious platinum ion exchange process utilizing colloidal dispersions has been implemented in an effort to mitigate hydrogen crossover in an electrochemical cell. One major drawback for such a process includes challenges for precise placement of the Pt ion on a thin membrane.

Therefore, there remains a need to develop an improved electrochemical cell having a thin membrane that will limit/mitigate hydrogen from crossing over to the anode side of the cell, therein preventing hydrogen from explosively reacting with oxygen in the cell. Specifically, there remains a need for a process that is more practical, easier to apply, more facile, and allows for greater flexibility in method, application, and placement of a hydrogen mitigation composition within a cell over the state of the art.

### BRIEF SUMMARY

In one embodiment, an electrochemical cell is disclosed. The cell includes a membrane configured to be positioned between an anode flow field and a cathode flow field of the electrochemical cell. The cell further includes a recombination layer configured to be positioned between the anode flow field and at least a portion of the membrane. The recombination layer includes a catalyst configured to assist in a formation of water from hydrogen gas and oxygen gas produced within the electrochemical cell, therein mitigating any hydrogen gas crossover from a cathode side to an anode side of the electrochemical cell.

In another embodiment, an electrochemical cell includes a multi-layered membrane configured to be positioned between an anode flow field and a cathode flow field of the electrochemical cell. The multi-layered membrane includes a first membrane layer configured to be positioned adjacent to the cathode flow field and a second membrane layer configured to be positioned adjacent to the anode flow field. Additionally, the multi-layered membrane is configured to assist in mitigating hydrogen gas crossover from a cathode side to an anode side of the electrochemical cell.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical cell.

FIG. 2 depicts an example of various layers within an electrochemical cell.

FIG. 3 depicts an additional example of various layers within an electrochemical cell.

FIG. 4 depicts an additional example of various layers within an electrochemical cell.

FIG. 5 depicts an additional example of various layers within an electrochemical cell.

FIG. 6 depicts an additional example of various layers within an electrochemical cell.

FIG. 7 depicts a chart showing a comparison between an electrochemical cell having a recombination layer versus an electrochemical cell without a recombination layer for the percentage of hydrogen gas in oxygen gas within the cell at varying operating conditions (current densities).

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

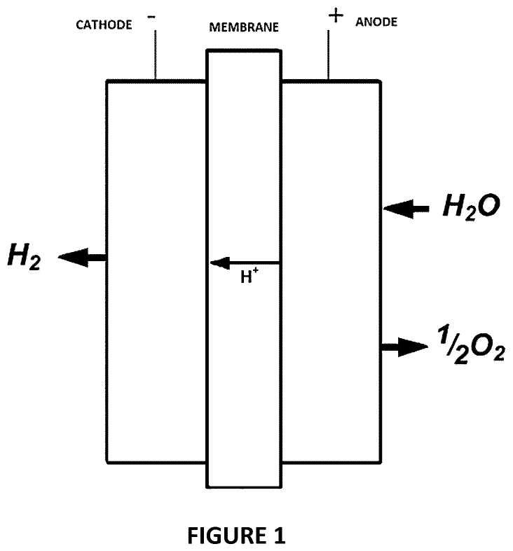

FIG. 1 depicts an example of an electrolytic cell for the production of hydrogen gas and oxygen gas through the splitting of water. The electrolytic cell includes a cathode, an anode, and a membrane positioned between the cathode and anode. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.”

Because the performance of a single electrolytic cell may not be adequate for many use cases, multiple cells may be placed together to form a “stack” of cells, which may be referred to as an electrolyzer stack, electrolytic stack, electrochemical stack, or simply just a stack. In certain examples, a stack may contain 50-1000 cells, 50-100 cells, 500-700 cells, or more than 1000 cells. Any number of cells may make up an electrochemical stack.

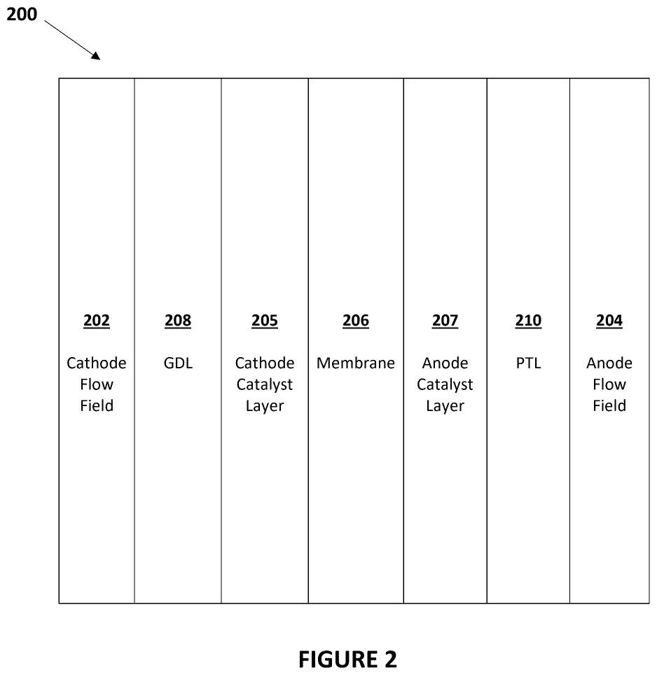

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

In some examples, an anode catalyst coating layer may be positioned between the anode flow field 204 and the PTL.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

As noted above, challenges are present for developing an electrochemical cell with a thin membrane that mitigates or prevents hydrogen crossover from the cathode (H₂) side to the anode (O₂) side of the cell.

In certain embodiments, an electrochemical cell with improved hydrogen mitigation characteristics may be provided through the addition of a recombination catalyst or recombination layer within the cell. Such a catalyst composition or recombination layer promotes the reaction of hydrogen with oxygen to form water. While the main purpose of the electrolytic cell is to split water to produce hydrogen and oxygen gas, this recombination reaction may advantageously mitigate the undesired crossover of such hydrogen gas from the cathode side to the anode side of the cell and prevent an explosive reaction.

### Recombination Compositions

In certain examples, the recombination composition or layer may include a recombination catalyst and, in some examples, one or more additional binder or filler compositions to form the composition or layer. In one example, the recombination catalyst may be a platinum-based nanoparticle catalyst combined with one or more ionomers in solution. Nanoparticle catalysts may refer to a catalyst having particles (e.g., platinum particles) with overall dimensions on a nanoscale, e.g., less than 1000 nanometers (nm), less than 100 nm, less than 10 nm, in a range of 0.1-1000 nm, 0.1-100 nm, 0.1-10 nm, 1-1000 nm, 1-100 nm, or 1-10 nm.

In some examples, the recombination composition may include nanoparticles of one or more catalyst compositions, herein referred to as “gas recombination catalysts” or “gas recombination compositions” or “GRCs.” The GRC may include one or more compounds or compositions such as platinum, platinum alloys, and supported catalysts. For instance, the composition may include, Pt—Ru, Pt—IrO₂, Pt—Ir, Platinum black, Pt—Co, Pt/C, or a combination thereof.

In certain examples, the GRC may include one or more support compositions. For example, in the case of a Pt/C catalyst alloy, the carbon support composition may include Carbon Black (e.g., Vulcan or Ketjen) or graphene, which provide desirable conductivity and surface area for the recombination composition.

The ratio of platinum to support or alloy within the recombination composition may be within a range of 1 part by weight platinum to 100 parts by weight support/alloy to 100 parts by weight platinum to 1 part by weight support/alloy (i.e. 1:100 Pt:support/alloy to 100:1 Pt:support/alloy). In other embodiments, the ratio may be in a range of 1:50 Pt:support/alloy to 50:1 Pt:support/alloy, in a range of 1:20 Pt:support/alloy to 20:1 Pt:support/alloy, in a range of 1:10 Pt:support/alloy to 10:1 Pt:support/alloy, in a range of 1:5 Pt:support/alloy to 5:1 Pt:support/alloy, or in a range of 1:2 Pt:support/alloy to 2:1 Pt:support/alloy. Higher ratios of platinum to support/alloy within the composition may advantageously provide more potent or effective recombination, and therefore may be favored for heavily biased cathode to anode pressurized electrolyzer applications.

In certain examples, the recombination composition (GRC), such as the non-limiting examples disclosed herein, may be subject to a pretreatment process prior to application or formation into a recombination layer within the electrochemical cell. The pretreatment process may include a heat treatment process to anneal the Pt (and any alloy or support composition, if present). Such a heat treatment process may occur at a temperature within a range of 400° C. to 900° C. This heat treatment or annealing process may be advantageous in adjusting or tuning an average or mean particle size, surface area, and/or porosity of the GRC composition.

Additionally, or alternatively, the pretreatment process of the GRC may include processing the GRC with a ball mill, battery mixer, or microfluidizer, for example, to advantageously provide better mixing within the GRC composition and/or modify (e.g., reduce) the (e.g., average or mean) particle size of the GRC composition and/or provide greater uniformity in the particle sizes of the GRC composition when needed.

In certain examples, the ionomer may be any polymeric composition having ionized units covalently bonded to a polymer backbone. In certain examples, the ionomer includes a medium or long side chain chemically stabilized perfluorosulfonic acid (MSC- or LSC-PFSA) ionomer and polytetrafluoroethylene (PTFE), such as commercially available in D1021 Nafion™ Dispersion. In other examples, the ionomer includes a short side chain chemically stabilized perfluorosulfonic acid (SSC-PFSA) ionomer and copolymer of tetrafluoroethylene (TFE) and sulfonyl fluoride vinyl ether (SFVE), such as commercially available in Aquivion® D72-25BS.

The presence of the ionomer in the solution is advantageous in reducing the amount of catalyst (e.g., platinum) needed by exposing a larger fraction of the catalyst to the hydrogen gas, while also acting as a binding agent to hold the catalyst layer together with the adjacent membrane layer and/or porous transport layer. Further, the ionomer within the recombination layer may be provided to advantageously prevent a short circuit within the cell.

In one embodiment, the ionomer in the solution is above 1000 equivalent weight to advantageously limit swelling and water transport and hence slow hydrogen transport in the recombination layer. In an alternative embodiment, the ionomer is lower than 1000 equivalent weight to advantageously promote faster proton transport.

In another embodiment, additional additives and/or catalysts may be present within the recombination layer. The additional additive or catalyst may be a scavenging agent such as Zirconia, Ceria/Ceria yttria-stabilized Zirconia, Cerium, Tungsten carbide, Cerium phosphate, Zirconium phosphate, a mixed metal oxide, or a combination thereof. Additionally, or alternatively, the additive may be a conducting additive such as poly(3,4-ethlenedioxythiophene) (PEDOT), low/medium/high surface area carbon, graphene, carbon black powder such as Super PR, or combinations thereof, which advantageously may improve conductivity or charge transport properties while, in some cases, also lowering the hydrogen crossover.

In certain examples, the recombination composition includes 1-100 wt. % GRC, 10-90 wt. % GRC, 20-80 wt. % GRC, 30-70 wt. % GRC, 40-60 wt. % GRC, or 20-50 wt. % GRC. In one example, the recombination composition may be formulated and applied to a surface of an adjacent layer within the cell via atomic layer deposition (ALD). In such cases, the recombination layer may be formulated from 100 wt. % catalyst (0 wt. % ionomer).

In some examples, the recombination composition further includes at least 1 wt. % binder and/or filler (e.g., including any ionomer present in the layer or additional additive), 10-90 wt. % binder and/or filler, 20-80 wt. % binder and/or filler, 30-70 wt. % binder and/or filler, 40-60 wt. % binder and/or filler, or approximately 50 wt. % binder and/or filler.

In additional examples, the recombination composition having the GRC may be mixed with an additional layer of the electrochemical cell to form a bilayer composition. In one example, the recombination composition or GRC may be mixed with the anode catalyst coating composition that is adjacent to the membrane surface on the anode side of the cell.

For example, the GRC may be mixed with the anode catalyst (e.g., IrO₂), e.g., using a ball mill, battery mixer, or microfluidizer. The ratio of anode catalyst to GRC within the mixed composition may be within a range of 1 part by weight of anode catalyst: 100 parts by weight of GRC to 100 parts by weight of anode catlayst: 1 part by weight of GRC (i.e., 1:100 anode catalyst:GRC to 100:1 anode catalyst:GRC). In other embodiments, the ratio may be in a range of 1:50 anode catalyst:GRC to 50:1 anode catalyst:GRC, in a range of 1:20 anode catalyst:GRC to 20:1 anode catalyst:GRC, in a range of 1:10 anode catalyst:GRC to 10:1 anode catalyst:GRC, in a range of 1:5 anode catalyst:GRC to 5:1 anode catalyst:GRC, or in a range of 1:2 anode catalyst:GRC to 2:1 anode catalyst:GRC.

In certain examples, the overall thickness of the recombination layer within an electrochemical cell is variable. For instance, in cases involving the formation of the recombination layer via atomic layer deposition (ALD), the thickness of the layer may be in a range of 0.1-100 nm, 0.1-10 nm, or 0.1-5 nm.

In other examples, the overall thickness of the recombination layer may be configured to be in a range of 0.1-50 microns, 1-25 microns, 1-10 microns, 1-5 microns, 10-30 microns, 25-50 microns, 10-25 microns, or 0.1-1 micron. In certain examples, such as where there is a greater differential pressure between the cathode and anode, the overall thickness of the recombination layer might be equivalent to a thickness of certain fuel cell membranes or even a portion of a thick electrolyzer, such as in a range of 10-30 or 25-50 microns.

Positioning and Configuration of Recombination Layer within Electrochemical Cell

In certain embodiments, the recombination composition or catalyst may be positioned on a surface of a membrane of the cell adjacent to the anode of the cell. The recombination composition may be coated onto the surface of the membrane in its own unique layer or combined with one or more additional compositions configured to coat the membrane.

This positioning of the recombination composition or layer on the anode side of the cell may be advantageous due to its position within an environment having oxygen gas. As the undesired hydrogen gas permeates through the membrane from the cathode side of the cell to the anode side of the cell, hydrogen gas, oxygen gas, and the recombination catalyst would be present together, wherein the catalyst would promote a reaction to recombine the hydrogen gas with the oxygen gas to form water. This produced water, already on the anode side of the cell, would be configured to transfer out from the cell with additional unreacted water from the water splitting reaction as well as produced oxygen gas which has not undergone the recombination reaction. As such, the undesired hydrogen gas on the anode side of the cell would be mitigated, and an explosion or dangerous operating condition of the electrochemical cell would be eliminated.

In certain examples, the recombination layer within the electrochemical cell may be designed or configured in such a way to have a concentration gradient through the layer in a direction extending perpendicular to the plane of the recombination layer. In other words, the concentration of the recombination catalyst at a first surface of the layer adjacent to the anode is different from the concentration at the second, opposite surface of the recombination layer adjacent to the membrane, and the concentration of the catalyst gradually increases or decreases from the first surface to the second surface to provide the concentration gradient.

In certain examples, the concentration of the recombination catalyst at the first surface of the recombination layer that is adjacent to the anode is lower than the concentration of the concentration of the recombination catalyst at the second, opposite surface that is adjacent to the membrane. This concentration gradient may be advantageous in providing a higher concentration closest to the membrane at the point at which hydrogen diffuses into the anode side of the cell, therein providing a higher opportunity for reaction and mitigation of the hydrogen gas. Further, having a lower concentration of the recombination catalyst adjacent to the anode may be advantageous in limiting any undesired reaction or interference between the recombination catalyst at the anode.

In an alternative example, the concentration of the recombination catalyst at the first surface of the recombination layer that is adjacent to the anode is higher than the concentration of the concentration of the recombination catalyst at the second, opposite surface that is adjacent to the membrane. This concentration gradient may be advantageous in providing a more advantageous location for the recombination process to occur due to sluggish transport properties of oxygen compared with hydrogen.

Formation of such a recombination layer with a gradient catalyst concentration may be completed through the creation of several batches of catalyst and ionomer or other filler/binder compositions, wherein each batch has a different ratio of catalyst to ionomer. The overall layer may be then formed through a deposition or extrusion process of each batch wherein the process begins with the lowest (or highest) concentration of catalyst to form a first layer and ends with the opposite highest (or lowest) concentration of catalyst to form a final layer of the overall recombination layer, therein creating the concentration gradient.

In other examples, the recombination layer disclosed herein may refer to a combination of a plurality of recombination layers that are separated from one another by ionomer layers, which may advantageously filter out any crossing over hydrogen gas and provide a larger oxidative network for it.

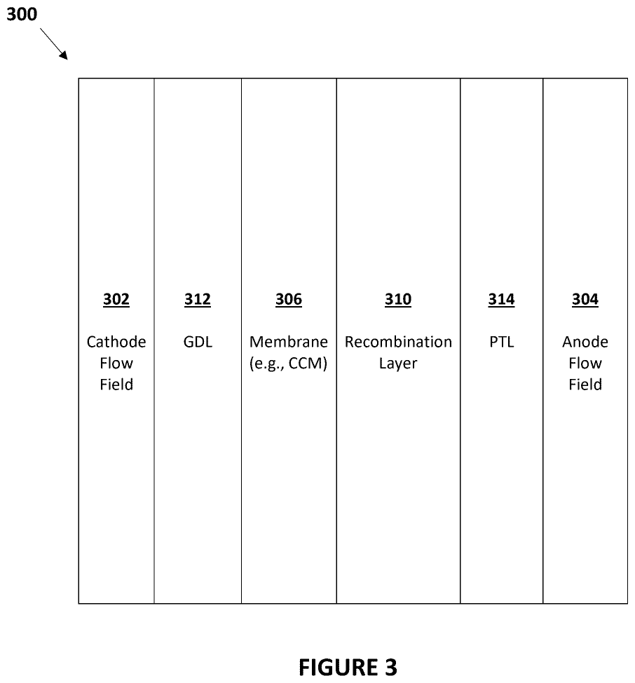

FIG. 3 depicts such example of a recombination layer positioned within an electrochemical cell. In this example, the electrochemical cell 300 includes a cathode flow field 302, an anode flow field 304, and a membrane 306 positioned between the cathode flow field 302 and anode flow field 304. While not depicted in FIG. 3, the membrane 306 within the electrochemical cell 300 may be a catalyst coated membrane (CCM) having a cathode catalyst layer adjacent to a first surface of the membrane and/or an anode catalyst layer adjacent to the opposite surface of the membrane (such as the example depicted in FIG. 2).

As depicted in FIG. 3, the electrochemical cell 300 further includes a recombination layer 310 having a gas recombination catalyst (GRC) 310. The recombination layer may be positioned adjacent to the membrane 306 (or anode catalyst coating on a surface of the membrane) such that the recombination layer 310 is positioned between the membrane 306 and the anode flow field 304. As noted above, the recombination layer 310 may include a GRC and one or more additional binder or filler compositions. The recombination layer 310 may have a gradient concentration of catalyst (GRC) through the layer. In some examples, the recombination layer 310 may include a plurality of layers as described above.

In certain examples, the membrane 306 has an overall thickness of less than 1000 microns, less than 500 microns, less than 100 microns, less than 50 microns, less than 25 microns, or less than 10 microns, etc., or a thickness in a range of 1-100 microns, 1-50 microns, or 1-25 microns. One non-limiting example of a commercially available thin membrane less than 25 microns includes DuPont's Nafion® 211. Alternative non-limiting examples of thicker membranes greater than 25 microns include DuPont Nafion® 212 or Nafion® 117.

In certain examples, the membrane 306 may be a reinforced membrane that advantageously provides mechanical strength to a thin membrane. Non-limiting examples of such reinforced membranes include Nafion® N-324, Nafion® XL, or Fumapem® FS-715-RFS. Further, other commercial ion exchange membranes available from Gore® may also be used within the electrochemical cells having a recombination layer described herein.

In certain examples, additional layers may be present within the electrochemical cell 300. For example, one or more additional layers 312 may be positioned between the cathode flow field 302 and membrane 306. In certain examples, this may include a cathode catalyst coating layer. Additionally, or alternatively, a gas diffusion layer (GDL) may be positioned between the cathode flow field 302 and membrane 306. This gas diffusion layer and/or cathode catalyst coating layer may be advantageous in providing a hydrogen diffusion barrier adjacent to the cathode on one side of the membrane to mitigate hydrogen crossover to the anode side. In some examples, a cathode catalyst coating layer may be positioned between the cathode flow field 302 and the GDL.

Similarly, one or more additional layers 314 may be present in the electrochemical cell between the membrane 306 or recombination layer 310 and the anode flow field 304. In certain examples, this may include an anode catalyst coating layer. Additionally, or alternatively, a porous transport layer (PTL) may be positioned between the membrane 206 or recombination layer 310 and the anode 304. In some examples, an anode catalyst coating layer may be positioned between the anode flow field 304 and the PTL.

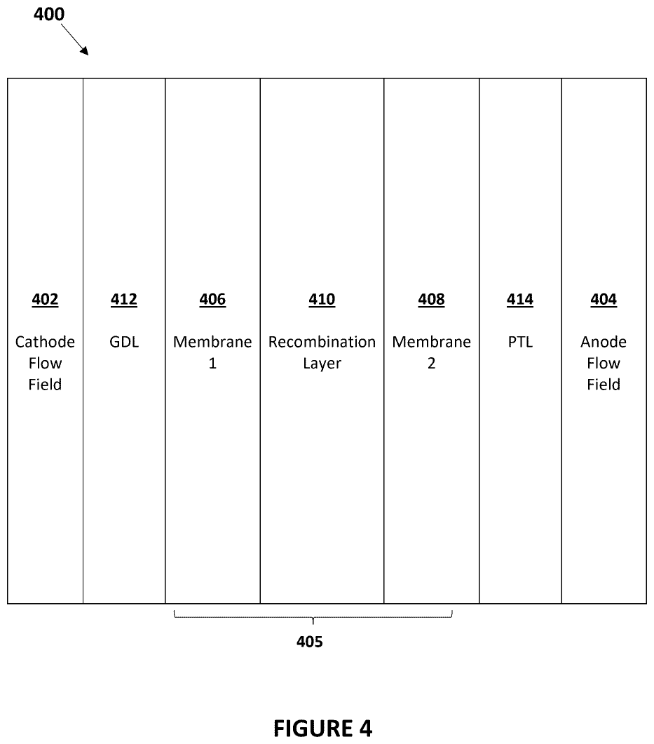

FIG. 4 depicts an additional example of a recombination layer positioned within an electrochemical cell. In this example, the electrochemical cell 400 includes a cathode flow field 402, an anode flow field 404, and a multi-layered membrane 405 positioned between the cathode flow field 402 and anode flow field 404. In this example, the multi-layered membrane 405 includes a first membrane layer 406 and a second membrane layer 408.

Further, a recombination layer or composition 410 may be positioned between layers of the multi-layered membrane 405 such that the recombination layer 410 is positioned between the first membrane layer 406 and the second membrane layer 408. As noted above, the recombination layer 410 may have a gradient concentration of catalyst through the layer. In some examples, the recombination layer 410 may include a plurality of layers.

Similar to the example described in FIG. 3, additional layers or coatings may be present between the cathode flow field 402 and anode flow field 404 such as a gas diffusion layer (GDL)/cathode catalyst coating layer 412 and/or a porous transport layer (PTL) or anode catalyst coating layer 414.

In this particular example in FIG. 4, the process of positioning the recombination layer 410 between two layers of a reinforced or unenforced membrane may be achieved through a process of coating the first membrane layer 406 with the recombination layer composition or catalyst and subsequently placing the second membrane layer 408 on top to sandwich the recombination composition. In some examples, this process may include providing a reinforced membrane such as a porous Teflon or PEEK scrim or similar material, subsequently coating the membrane layer with the recombination layer, and then subsequently coating the recombination layer with an ion exchange polymer to create a reinforced multi-layered membrane with the recombination material at its heart.

Positioning the recombination composition 410 between two layers of a multi-layered membrane 405 may be advantageous in providing a concentration profile that has a peak in a concentration of a selected agent or catalyst within the middle or near the center of the multi-layered membrane (e.g., within a coating layer between the two membrane layers). Additionally, or alternatively, the multi-layered membrane 405 may be advantageous in providing a configuration where the recombination composition or catalyst is protected by the adjacent membrane layers 406, 408, such that the agent/catalyst is not directly exposed to the reactant components on either outer surface of the membrane at the anode or cathode.

Another advantage of the multi-layered membrane 405 is that its design may allow for the addition of recombination layer compositions with desirable transport properties but challenging mechanical properties. That is, the multi-layered membrane design may allow for the addition of an internal recombination coating layer that includes the desirable properties but inadequate mechanical properties that are supported and strengthened by the surrounding membrane layers such that the overall multi-layered membrane is mechanically sound for inclusion within the electrochemical cell.

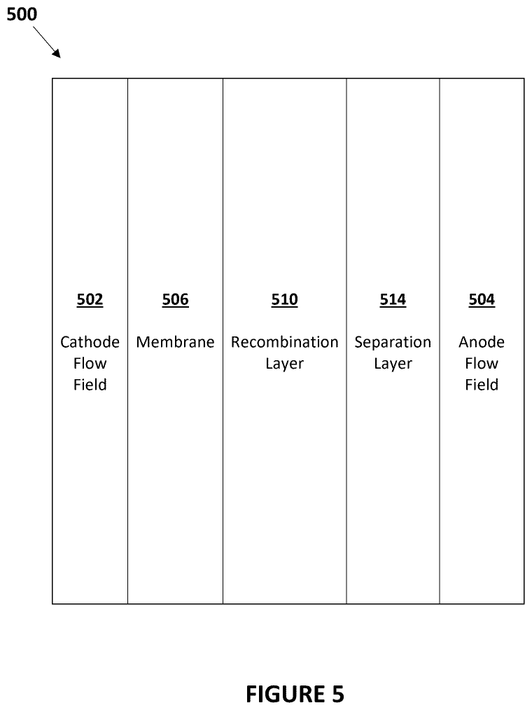

FIG. 5 depicts an additional configuration for an electrochemical cell 500 having a recombination layer. In this example, the electrochemical cell 500 includes a cathode flow field 502, an anode flow field 504, and a membrane 506 positioned between the cathode flow field 502 and anode flow field 504. The membrane 506 may be a single layer or a multi-layer membrane with internal catalyst or coating composition layers positioned between two or more membrane layers. As noted above, the membrane 506 may be a reinforced or unenforced membrane.

Further, a recombination layer 510 is positioned between the anode flow field 504 and the membrane 506. As noted above, the recombination layer 510 may have a gradient concentration of catalyst through the layer. In some examples, the recombination layer 510 may include a plurality of layers.

In this example, an additional layer 514 is present between a surface of the anode flow field 504 and the recombination layer 510 such that the recombination layer 510 is offset or separated from the boundary of the anode flow field 504. In certain examples, the separation or offset between the two layers is in a range of 1-20 microns, 5-15 microns, approximately 10 microns, or any other designed distance. This separation layer 514 may be applied to a surface of the recombination layer 510 to better separate the recombination layer catalyst composition from the anode and better control the hydrogen permeation kinetics within the cell.

In certain examples, the separation layer 514 may be a porous transport layer (PTL) or anode catalyst coating composition layer as described above.

Further, while not depicted within FIG. 5, additional layers or coatings may be present, such as a gas diffusion layer (GDL) or cathode catalyst coating composition positioned between the membrane 506 and the cathode flow field 502 of the cell 500.

### Mitigation of Hydrogen Using Multi-Layered Membrane

In certain embodiments, mitigation of hydrogen within an electrochemical cell may be achieved through the presence of a multi-layered membrane, potentially without the presence of a separate recombination layer entirely. For instance, an electrochemical cell may include at least two separate membrane layers positioned adjacent to each other. The interface or transition between the adjacent layers may advantageously restrict the flow of hydrogen from the cathode side of the cell to the anode side of the cell. In other words, hydrogen gas may be mitigated from flowing into the anode of the cell based on the flow dynamics provided within a multilayered membrane (e.g., at the interface between two adjacent layers of the membrane).

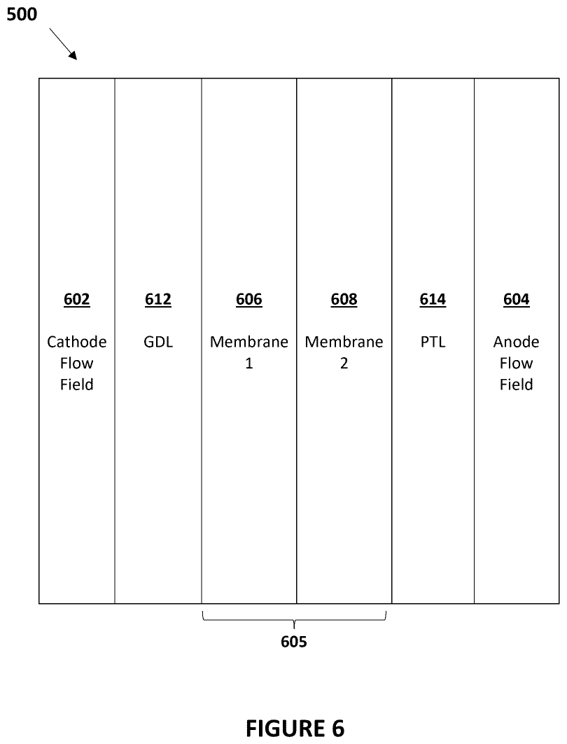

FIG. 6 depicts an example of such an electrochemical cell 600. In this example, the electrochemical cell 600 includes a cathode flow field 602, an anode flow field 604, and a multi-layered membrane 605 positioned between the cathode flow field 602 and anode flow field 604. In this example, the multi-layered membrane 605 includes a first membrane layer 606 and a second membrane layer 608.

Similar to the examples described above, additional layers or coatings may be present between the cathode flow field 602 and anode flow field 604 such as a gas diffusion layer (GDL)/cathode catalyst coating layer 612 and/or a porous transport layer (PTL) or anode catalyst coating layer 614.

In this example, the first membrane layer 606 may have a similar or different composition from the second membrane layer 608 to provide the change in flow dynamics at the interface between the two layers.

Further, in certain examples, the first membrane layer 606 and/or the second membrane layer 608 may be reinforced membrane layers.

Methods of Making and Applying Recombination Layers within an Electrochemical Cell

The process of forming the recombination layer may include an ex-situ process, wherein a solution of recombination catalyst and one or more additives/binders/fillers is formed. The recombination composition solution may be subsequently applied to a surface of an adjacent layer within the electrochemical cell or a substrate through a variety of different methods. The viscosity of the recombination composition solution be adequately tuned to perfect any of these process methods.

In one example, the solution having the gas recombination catalyst (GRC) and one or more additives/binders/fillers may be spray coated onto an adjacent layer of the cell (e.g., the anode or membrane) or a substrate using a spray brush and ultrasonic sprayer.

In another example, the solution may be casted with a myer rod, doctor blade, gravure, or casting knife.

In another example, the solution may be first sputter coated or added using ALD (atomic layer deposition).

The flexibility of the process advantageously allows any of these deposition techniques to also apply the recombination directly to the anode catalyst coating layer or porous transport layer on the anode side of the cell (instead of the membrane).

Additionally, or alternatively, to supplement and further mitigate hydrogen crossover, the GRC may be more directly combined with the anode catalyst coating. For example, the GRC (e.g., including inks containing any of the materials described above), may be mixed with the anode catalyst (e.g., IrO₂), e.g., using a ball mill, battery mixer, or microfluidizer. The ratio of anode catalyst to gas recombination catalyst within the mixed composition may be within a range of 1 part by weight of anode catalyst: 100 parts by weight of GRC to 100 parts by weight of anode catlayst: 1 part by weight of GRC (i.e., 1:100 anode catalyst:GRC to 100:1 anode catalyst:GRC). In other embodiments, the ratio may be in a range of 1:50 anode catalyst:GRC to 50:1 anode catalyst:GRC, in a range of 1:20 anode catalyst:GRC to 20:1 anode catalyst:GRC, in a range of 1:10 anode catalyst:GRC to 10:1 anode catalyst:GRC, in a range of 1:5 anode catalyst:GRC to 5:1 anode catalyst:GRC, or in a range of 1:2 anode catalyst:GRC to 2:1 anode catalyst:GRC. In some examples, the amount of anode catalyst (e.g., IrO₂) and GRC within the mixture may be tuned by adjusting the thickness of the deposited hybrid GRC and anode coating.

In certain examples, the hybrid coating having both anode and gas recombination catalysts may be deposited directly onto the anode side surface of the membrane using a deposition process as disclosed herein. Alternatively, the hybrid coating may be deposited onto a substrate such as polytetrafluoroethylene (PTFE) or ethylene tetrafluoroethylene (ETFE), and subsequently decaled onto the membrane surface.

In another embodiment, the deposition process may include depositing the anode catalyst composition onto a substrate such as PTFE or ETFE. Subsequently, the GRC composition could be deposited or coated onto the exposed surface of the deposited anode catalyst. Following these separate deposition processes, the combined bilayer coating could be decaled onto the membrane surface.

In yet another embodiment, a multi decal/hot press process could be implemented. In such a process, the GRC could be deposited or coated onto a substrate such as PTFE or ETFE. The GRC/substrate could then be hot pressed to the membrane. Subsequently, the anode catalyst coating could be hot pressed to the GRC side of the same membrane.

### EXAMPLES

A first electrochemical cell is provided having a recombination layer as described herein. A second electrochemical cell is also provided that is similar to the first cell but does not include a recombination layer.

Tests on the cells are conducted at varying levels of current density, wherein hydrogen crossover is measured on the anode side of the cell. That is, the percentage of hydrogen gas in oxygen gas is measured at the varying levels of current density.

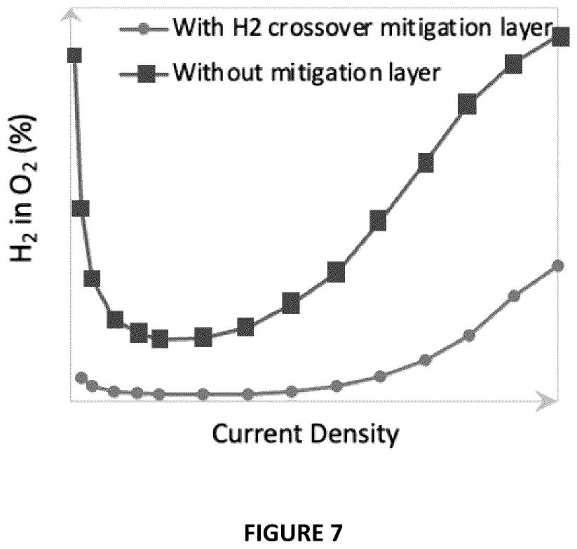

FIG. 7 depicts a chart showing a comparison between the first electrochemical cell having a recombination layer and the second electrochemical cell without a recombination layer. The chart provides an exemplary graph of the percentage of hydrogen gas in oxygen gas at varying levels of current density. As shown within the figure, the expectation is that the recombination layer provides a mitigation or reduction in the percentage of hydrogen gas in the oxygen gas as measured on the anode side of the cell throughout the operating range of current density for the cell.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. An electrochemical cell comprising:
an anode flow field;
a cathode flow field;
a membrane positioned between the anode flow field and the cathode flow field; and
a recombination layer positioned between the anode flow field and the membrane,
wherein the recombination layer comprises a catalyst configured to assist in a formation of water from hydrogen gas and oxygen gas produced within the electrochemical cell, therein mitigating any hydrogen gas crossover from a cathode side to an anode side of the electrochemical cell.

2. (canceled)

3. The electrochemical cell of claim 1, wherein the catalyst of the recombination layer comprises platinum.

4. The electrochemical cell of claim 1, wherein the catalyst of the recombination layer comprises platinum on carbon, platinum-ruthenium, platinum-iridium oxide, platinum black, platinum-cobalt, or a combination thereof.

5. The electrochemical cell of claim 1, wherein the recombination layer further comprises an ionomer.

6. The electrochemical cell of claim 5, wherein the ionomer comprises a chemically stabilized perfluorosulfonic acid (PFSA) ionomer and polytetrafluoroethylene (PTFE).

7. The electrochemical cell of claim 5, wherein the ionomer comprises a chemically stabilized perfluorosulfonic acid (PFSA) ionomer and copolymer of tetrafluoroethylene (TFE) and sulfonyl fluoride vinyl ether (SFVE).

8. The electrochemical cell of claim 1, wherein the recombination layer further comprises an additive or additional catalyst.

9. The electrochemical cell of claim 8, wherein the additive or the additional catalyst comprises a scavenging agent.

10. The electrochemical cell of claim 9, wherein the scavenging agent is Ceria or Zirconia.

11. The electrochemical cell of claim 8, wherein the additive comprises a conducting additive.

12. The electrochemical cell of claim 11, wherein the conducting additive is poly(3,4-ethlenedioxythiophene) (PEDOT).

13. The electrochemical cell of claim 8, wherein the additional catalyst comprises a membrane coating catalyst.

14. The electrochemical cell of claim 13, wherein the membrane coating catalyst comprises iridium oxide (IrO₂).

15. The electrochemical cell of claim 1, wherein the membrane is a reinforced membrane.

16. (canceled)

17. The electrochemical cell of claim 1, further comprising:
a porous transport layer positioned between the anode flow field and the recombination layer.

18. The electrochemical cell of claim 1, further comprising:
a separation layer positioned between the anode flow field and the recombination layer.

19. The electrochemical cell of claim 1, wherein the recombination layer has a gradient concentration of the catalyst within the recombination layer, and
wherein a higher concentration of the catalyst is present at one surface of the recombination layer in comparison to a concentration of the catalyst at an opposite surface of the recombination layer.

20. An electrochemical cell comprising:
a multi-layered membrane configured to be positioned between an anode flow field and a cathode flow field of the electrochemical cell,
wherein the multi-layered membrane comprises a first membrane layer configured to be positioned adjacent to the cathode flow field and a second membrane layer configured to be positioned adjacent to the anode flow field,
wherein the multi-layered membrane is configured to assist in mitigating hydrogen gas crossover from a cathode side to an anode side of the electrochemical cell, and
wherein the first membrane layer and/or the second membrane layer is a reinforced membrane layer.

21. The electrochemical cell of claim 20, wherein the first membrane layer has a different composition than the second membrane layer.

22. (canceled)

23. The electrochemical cell of claim 20, further comprising:
a porous transport layer configured to be positioned between the anode flow field and the multi-layered membrane.

24. (canceled)
